(19) United States
(12) Patent Application Publication
(10) Pub. No.: US 2008/0032579 A1
(43) Pub. Date: Feb. 7, 2008

(54) Spunbond Fleece of Polymer Fibers and Its Use

(76) Inventors: Jean-Claude Abed, Simpsonville, SC (US); Eduard Herda, Peine (DE); Henning Roettger, Kaltenkirchen (DE); Ralf Sodemann, Peine (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/599,721

(22) PCT Filed: Apr. 6, 2004
(86) PCT No.: PCT/EP04/03612

§ 371 Date: Jul. 30, 2007

(51) Int. Cl. B32B 5/26

(52) U.S. Cl. 442/239

(57) ABSTRACT

The invention relates to a spun-bonded non-woven made of polymer fibers. These polymer fibers have a non-circular cross-section and a low fiber count. The polymer fibers have predominant directions in the spun-bonded non-woven. The spun-bonded non-woven has a high optical and/or physical opacity while having a low mass per unit area.

The present invention relates to a spunbond polymer-fiber fleece which has low permeability to light, liquid materials, and solid materials as well as to the use of such a fleece.

Fleeces which are produced according to a spunbond process in which the spun fibers are laid, directly after they are spun, on a transport belt, where they form a fleece, are well known according to the state of the art and are used in many fields, such as, for example, in the construction, textile, automobile, hygiene, etc. industries. Depending on the field of application, the fleeces are produced with a definite profile of properties. It is also known that the fibers in this application can have round or non-round cross sections with, for example, a delta-shaped, trilobal, or flat form, where the required fleece properties, depending on the field of application of the fleece, can be adjusted in various ways, e.g., by variation of the fiber titer, fiber cross section, fleece hardening, weight per unit area, and so on.

From U.S. Pat. No. 3,630,816 a spunbond fleece with flat fibers of polypropylene whose cross section has a ratio of length to width of 3:1 to 8:1 is known. Therein the fibers are disposed randomly and essentially separated from one another, with the exception of crosspoints, and have cross-sectional surfaces of 0.00005 to 0.008 mm² as well as a fiber titer of ca. 6 to 13 denier. After the stretching of the fibers, tensile strengths of 2 to 5 g/denier and extensions of 50 to 400%, depending on the stretching conditions, were determined. The fleeces produced in so doing have base weights between 17 and 1.490 g/m², densities between 0.2 and 0.7 g/cm³, and thicknesses between 0.127 and 7.62 mm. Fleeces of this type have in comparison to fleeces of round fibers higher resistances to tearing and are used, e.g., for insulation purposes, for reinforcing paper and material, as filter materials, or as an underlay felt for carpets.

In U.S. Pat. No. 5,458,963 a fleece is disclosed which consists of fibers with a three-legged or six-legged cross section and the legs are disposed in such a manner that an applied liquid is absorbed due to the contact angle between the formed fiber and the liquid present in the formed fiber and is transported against a pressure to locations which are distant from the location of the application of the liquid. These fleeces have densities of approximately 0.01 to 0.5 g/cm³, thicknesses between 0.5 μm to 0.05 m, and fiber titer of ca. 2 to 3 denier.

Fiber structures of fibers with non-round cross section for products with thermal insulation properties are claimed in U.S. Pat. No. 5,731,248. Therein the fibers are produced with a titer from 2 to 15 denier and a definite form factor, as a function of the peripheral surface and the cross-sectional surface of the fiber. The fibrous structures have a specific volume of approximately 1.5 to 5 cm³/g [sic], and in the uncompressed state a density of 0.005 to 0.05 g/cm³ as well as a thickness of less than 1.27 cm.

In JP 1201566 and 1201567 voluminous spunbond fleeces of fibers with non-round cross section and, due to this, greater fiber surface in comparison to round fibers, are described, where these fleeces have weights per unit area≦50 g/cm² and thicknesses≦5 mm.

A multi-layer fleece material consisting preferably of a polyolefin with bilobal or trilobal or branched fibers which has, due to this composition, an increased softness and tensile strength, is disclosed in DE 3643139 A1. Therein the trilobal or branched fibers can be moistened better than the bilobal fibers. In these fleeces, consisting of at least two layers, base weights of approximately 28-40 g/cm² and tensile strengths in the machine direction between approximately 18 to 58 N were determined.

An absorbent article with a transport layer for liquids which ensures improved flow directions for these liquids is described in EP 549781 B1. This is achieved by the fact that hydrophilic fibers with outer capillary channels, which, for example, are C-shaped and comprise stabilizing legs, are used and they are disposed in such a manner that there is a multi-dimensional liquid transport.

From DE 68914387 T2 a carded fleece of staple fibers with trilobal, quadralobal, round, square, or rectangular cross section is known, where the fleece is soft, water-tight, and opaque.

In EP 782639 B1 a fleece consisting of bi-component fibers with a core-jacket structure and with a band-like cross section is described, which leads to an increased opacity or covering of the material and is suitable for textiles such as, for example, automobile coverings, umbrellas, curtains, tarpaulins, and so on. For the absorption or reflection of ultraviolet radiation, substances such as micronized titanium dioxide or zinc dioxide are added to the polymer melt.

However, the measures known from the state of the art for reducing the permeability of fleeces to light, liquid materials, and solid materials cause an increased expenditure or an increased use of material in the production of the fleece.

At this point the invention enters in. It is worth striving for to provide a fleece material which comprises polymer fibers which are formed in such a manner and are disposed in the fleece material in such a manner that they have a high fiber overlap and in the fleece material cause a low permeability to light, liquid materials, and solid materials without the additional use of dyes, raw materials, and additives.

This objective is realized with the features of claim 1. The present invention provides for a fleece material of polymer fibers, where the fibers have a non-circular cross section and low fiber titer. Along with this, the polymer fibers are laid in preferred directions in the spunbond process. For hardening the spunbond fleece, an adhesive can be applied to the fleece. In the hardened state the spunbond fleece has a high optical and physical opacity with a low weight per unit area.

In such a fleece, the optical opacity is measured as the reduction of the light permeability through the fleece.

The determination of the reduction of the light permeability through a fleece is done using a light table. In this determination, a light source, which is located beneath the light table, is directed toward this light table and, via a sensor which is disposed above the light table, the intensity of the light passing through the light table is measured as a gray value. This gray value corresponds to a light permeability of 100%. Subsequently, a fleece is positioned on the light table and the light intensity is measured once again, where the difference between this value and 100% corresponds to the reduction of the light permeability.

The air permeability through the fleece and the sieve residue on the fleece are drawn upon to describe the physical opacity.

The measurement of the air permeability of fleece materials is done according to DIN EN ISO 9237.

The sieve residue on the fleece material is determined in a defined shaking process using a testing sieve shaker, Model B of the C-E Tyler company and using a superabsorber as sieve feed and is based on a measurement of the difference in weight by determining the portion of superabsorber which remains on the fleece to be investigated after the defined shaking process.

In one form of embodiment of the invention the spunbond fleece comprises polymer fibers with a flat or trilobal structure, whereby in the laid fleece significantly higher overlap cross sections appear than in the case of fleeces with fibers of round structure at the same titer. The use of trilobal fibers leads, e.g., in the laid fleece, to an overlap of the fibers which is ca. 30% higher than the overlap which appears using fibers with a round cross section.

For the production of spunbond fleece, polymers are melted in an extruder and polymer fibers are spun from a spinnerette with a plurality of orifices and subsequently stretched in an air stream and/or mixture of air and steam. The stretched polymer fibers are laid in a preferred direction along and transverse to the machine direction, that is, predominantly perpendicular to the z-direction on a sieve belt. The fleeces thus obtained can, for example, be hardened by thermobonding. In so doing, the fiber titers lie in the range of 0.5 dtex to 5 dtex, preferably between 1.4 dtex and 3.5 dtex. The fleeces thus obtained have weights per unit area, measured according to DIN EN 29073-1, from 7 g/m² to 50 g/m², preferably 10 g/m² to 20 g/m².

According to the invention, the fleece has a higher opacity than traditional fleeces. The optical opacity of the fleece, i.e., the reduction of the light permeability, can be improved, among other things, by
the addition of additives, such as, for example, matting agents, to the polymer melt before spinning,
the application of strongly textured fibers in the production of fleece, in particular of staple fibers,
the increase of the fiber titer with simultaneously increasing weight per unit area of the fleece, or
an increase of the weight per unit area of the fleece with a fiber titer remaining stable.

The physical opacity of the fleece, i.e., an impermeability for media such as, for example, air, water, powder, and so on, is also increased by
an increase of the fiber titer,
a texturing of the fiber,
an increase of the weight per unit area.

In multi-layer products of fleece a hot adhesive can be applied during the production of the composite. In so doing, the adhesive is, for example, applied in the melted state on one side of the fleece in order to connect it to another layer. In so doing, it is undesirable that the adhesive penetrates the fleece. The penetration of adhesive can also be reduced by increasing the weight per unit area, that is, by a higher layer thickness of the fleece.

The increased opacity of the fleece according to the invention is achieved by a combination of optical and physical measures without the additional use of dyes, raw materials, and additives. For this, suitable measures are, for example,
the targeted choice of the polymer, where, for example, the natural turbidity of the polypropylene increases with increasing MFI and with a broad molecular weight distribution,
the choice of the processing parameters for spinning, for cooling, and for stretching the polymer, since a greater turbidity of the polymer fibers is achieved by a slower fiber cooling during spinning and by less fiber stretching,

the use of additives, where the turbidity is increased by the addition of matting agents such as, for example, titanium dioxide, calcite, and so on to the polymer melt before spinning,
the structuring of the fiber surface, that is, the production of fibers with a non-round, preferably a trilobal, multi-lobal, or flat form of the fiber cross section,
the arrangement of the fibers in the fleece perpendicular to the z-direction and in the preferred direction in the machine direction and transverse to the machine direction so that a greater fiber overlap is achieved.

In the comparison of fleeces with the same weight per unit area and at the same titer, the spunbond fleece according to the invention has an optical opacity, measured as the reduction of the light permeability, of 5 to 20%, preferably 6-9%, relative to the weight per unit area. That is, the light permeability of the fleece is reduced with the use of trilobal fibers, preferably by 6-9%. In comparison thereto, the use of round fibers for the production of a fleece only leads to a reduction of the light permeability of 1-4%.

To harden the spunbond fleece, an adhesive can be used, where the portion of adhesive per m² of spunbond fleece on an order of magnitude of 0.5 g to 10 g, preferably 3 g to 6 g, is added.

In so doing, the adhesive used has, in the temperature range between 140° C. and 160° C., dynamic viscosities in the range of 3000 mPas to 33000 mpas, preferably 4000 mPas to 6000 mpas. The penetration of the adhesive through the fleece is reduced due to the fact that the fibers, due to the non-round form of the fiber cross section, i.e., a flat, oval, trilobal, or multi-lobal form, have an increased fiber surface in comparison to fibers with a round cross section at the same titer and in the laid fleece a greater fiber overlap is achieved. Associated therewith, the longer and narrower flow paths between the fibers slow the rate of spreading of the adhesive in such a manner that the hardening of the adhesive occurs before it penetrates the fleece.

Furthermore, the polymer melts which are used for spinning the fibers can comprise additives which have a high heat storage capacity and rapidly draw heat from the melted adhesive in the laid fleece during the moistening and penetration of the fleece so that the adhesive hardens in the fleece without in so doing completely penetrating it.

According to an additional form of embodiment the physical opacity of the spunbond fleece relative to the weight per unit area, measured as sieve residue, assumes values in the range of 75% to 99%, preferably between 90% and 95%. Here, a shaking time of 20 minutes was set.

The spunbond fleece according to the invention has in an additional form of embodiment a physical opacity relative to the weight per unit area, measured as air permeability, in the range from 6·10³l/m² sec to 9·10³ l/m² sec, preferably between 7·10³1/m² sec and 8·10³l/m² sec.

For the production of the polymer fibers of the spunbond fleece, polymers from the group comprising polyolefins, PA, polyester, preferably polypropylene, are used.

For the production of the spunbond fleece according to the invention, for example, a polypropylene produced according to the Ziegler-Natta process with a molecular weight distribution M_{w}/Mₙ>3 and with an MFI≧25 g/10 min can be used. During the spinning process inorganic salts such as, for example, titanium oxides and/or calcium carbonates are preferably used as an additive with a high heat storage capacity, where such additives are added to the polymer melt at between 0.1 an 5% by weight, preferably between 0.2 and 0.7% by weight without an additional nucleating agent being used. The fibers formed in this way are slowly cooled during their production and before their laying, for example, on a sieve belt. In order to achieve slow cooling of the fibers, cool air with a temperature>20° C. is preferably used. The fibers are stretched slightly so that they have an extension>200%. The laid fleeces have weights per unit area between 7 g/m² and 50 g/m², preferably between 10 g/m² and 20 g/m².

Along with this, the highly structured surface fiber surface can be trilobal, tetralobal, pentalobal, or hexalobal or have a flat, oval, Z-form, S-form, or keyhole form for the fiber cross section.

At the same time, the form of the fiber cross section makes possible a different material distribution in the fiber than in the case of round fibers by fibers being able to be formed with several legs and the diameter of the fibers, or the projected leg or edge length, thus being greatly increased in comparison to round fibers at the same titer. Due to this, a greater overlap of the fiber cross sections can be achieved in the laid fleece, which leads to a higher resistance force of the fibers among themselves and, for example, increases the resistance of such fibers to the penetration of adhesive.

Fleeces of this type have in comparison to the traditional fleece with the same weight per unit area a higher optical and physical opacity and a higher resistance to the penetration of adhesive.

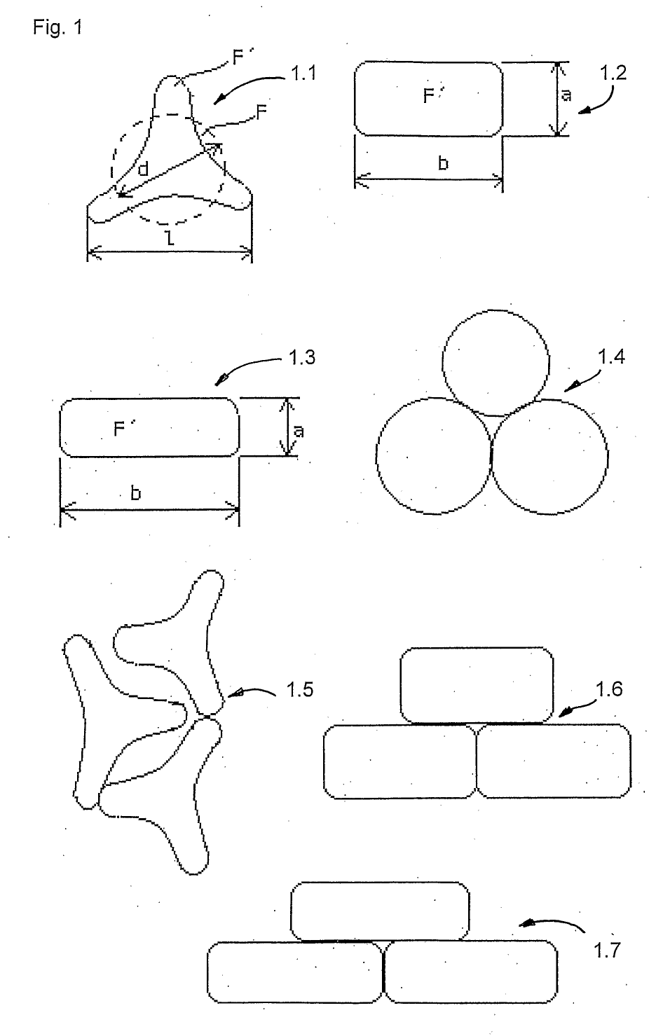

FIG. 1 is a schematic representation of fibers whose fiber cross section has a round, flat, and trilobal form, as well as of their overlap.

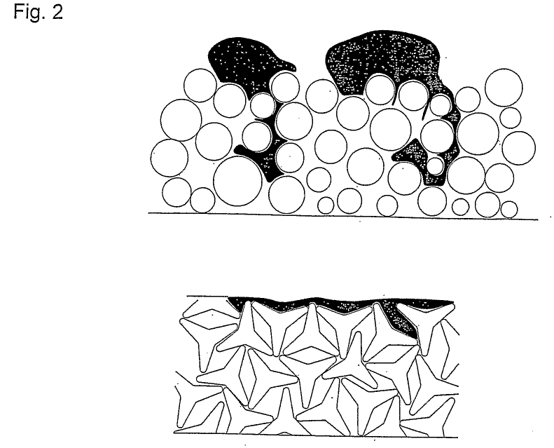

FIG. 2 is a schematic representation of the adhesive passage for fleeces with round fibers and fleeces with trilobal fibers.

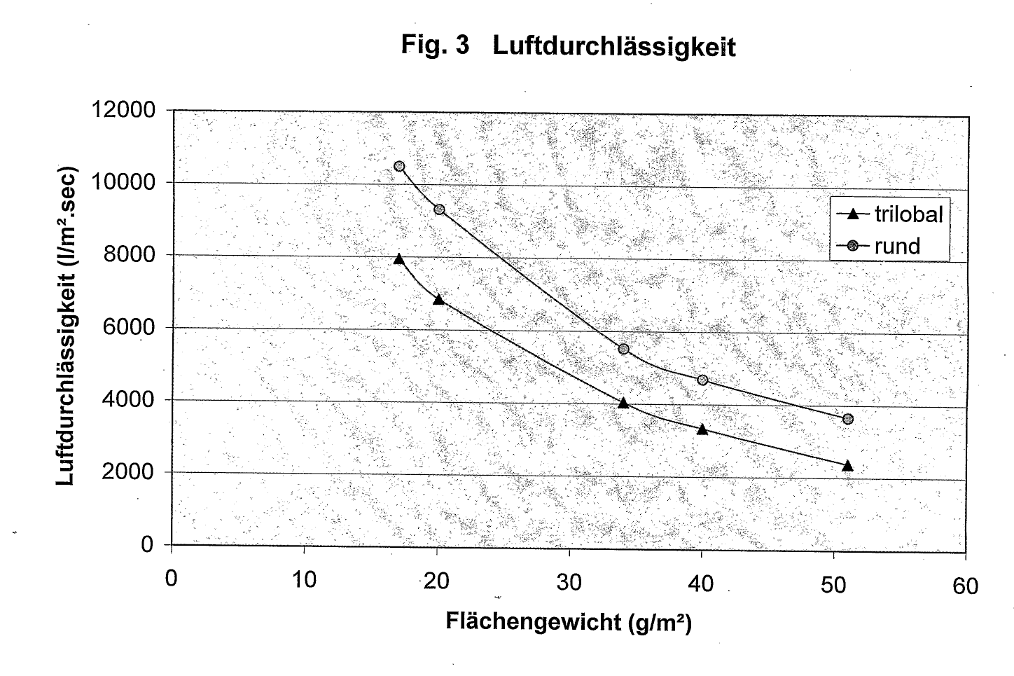

In FIG. 3 the reduction of the light permeability [sic] as a function of the weight per unit area of the fleece and of the form of the fiber cross section is shown.

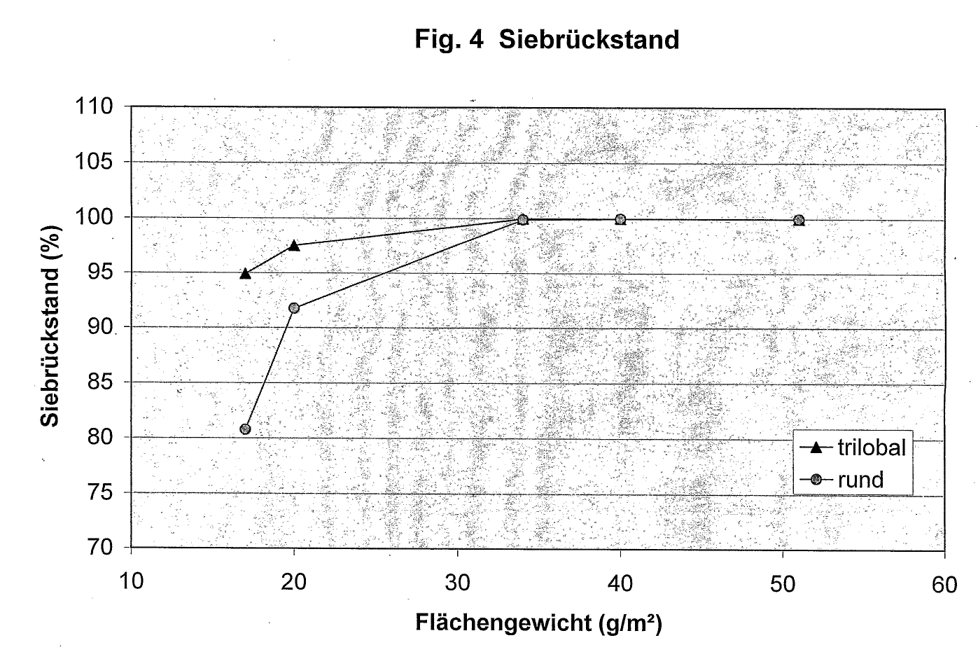

In FIG. 4 the air permeability [sic] as a function of the weight per unit area of the fleece and of the form of their fiber cross section is represented.

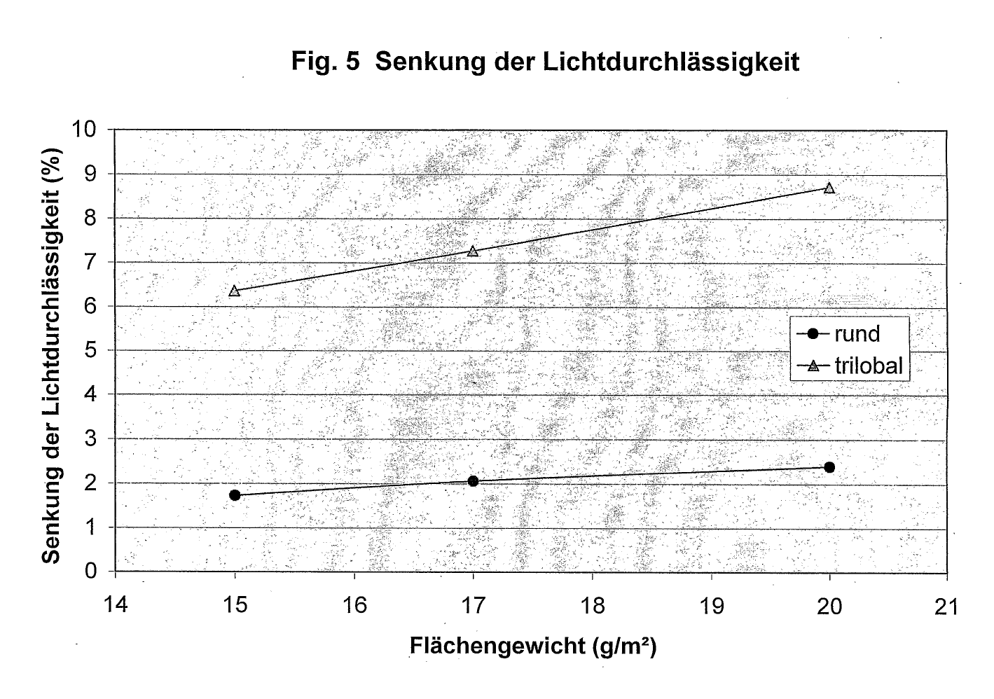

In FIG. 5 the relationship between the sieve residue [sic] and the weight per unit area of the fleece is represented for different fiber cross sections.

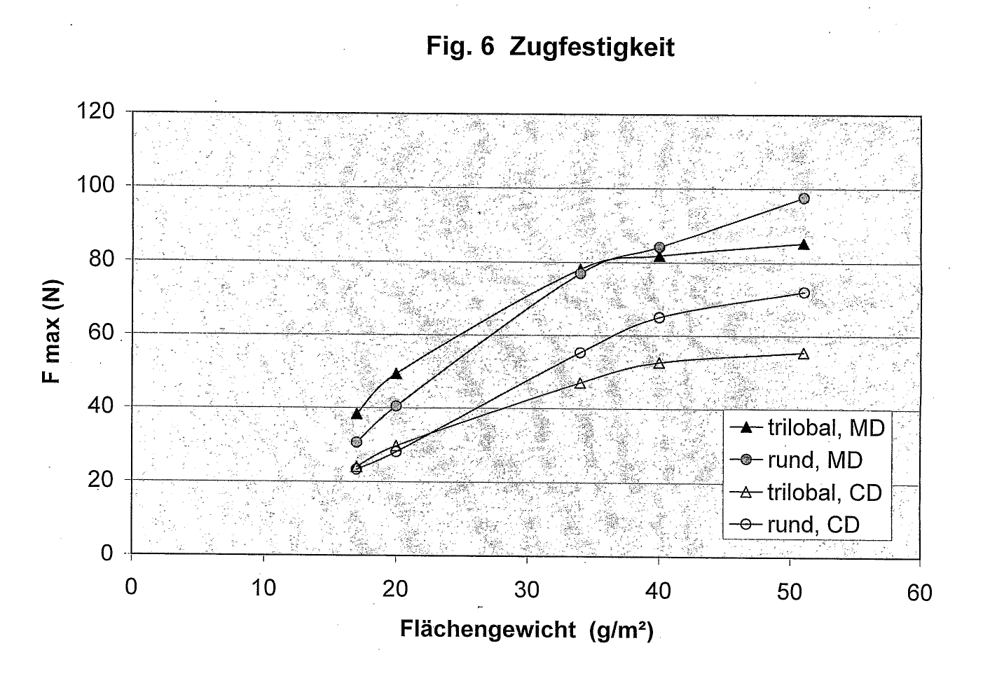

FIG. 6 gives an overview of the development of the tensile strength of the fleece in the machine direction and transverse to the machine direction as a function of the weight per unit area of the fleece and of the form of the fiber cross section.

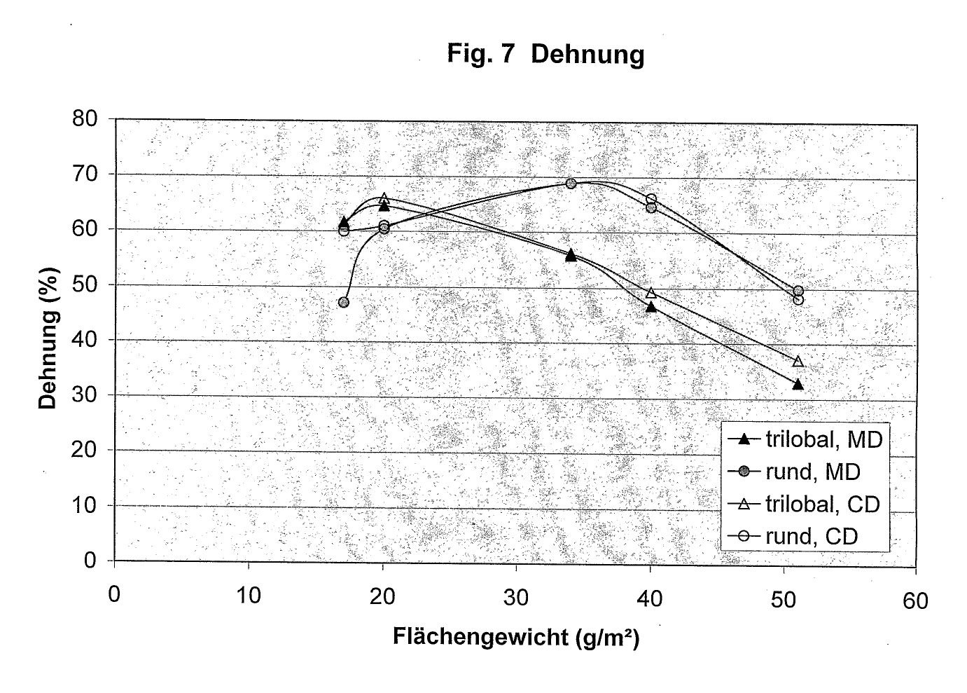

FIG. 7 shows the fleece extension in the machine direction and transverse to the machine direction for fleeces with trilobal and round fleeces.

FIG. 1 illustrates the cross sections of the fibers considered in more detail in the scope of the invention. The representation 1.1 shows a circular cross section F which has the same surface area as the surface F′ which belongs to a trilobal fiber, where it can be seen that the projected edge length 1 of the fibers with a trilobal form for the cross section is ca. 30% larger than the diameter d of the fiber with a round cross section, which corresponds to a ratio 1=1.3 d. If according to the invention these trilobal fibers are laid in the preferred direction perpendicular to the Z-direction, i.e., in the machine direction and/or transverse to the machine direction, to form a fleece, a fiber overlap can consequently be achieved which is 30% higher than the maximum possible overlap which would be achievable using round fibers. Flat fibers with an edge ratio b=2a according to FIG. 1.2 have in comparison to round fibers a ca. 25% greater projected edge length and fibers with an edge ratio of b=3a according to FIG. 1.3 a ca. 53% greater edge length. The FIGS. 1.4 to 1.7 illustrate the facts of fiber overlap.

FIG. 2 shows by way of example how, according to the laid fleece's gap volume present in the case of the fiber geometry in question, an adhesive can penetrate through the fleece, or in the more favorable case only penetrate into the fleece and harden the fleece without going through it. With this, it becomes clear that through the use of trilobal fibers a higher packing density within the fleece is achieved and the narrower flow paths associated therewith reduce the penetration of the adhesive drastically.

The invention will be explained in more detail with the aid of examples in order to present a comparison between fleece with round fibers and fleeces with trilobal fibers with regard to their permeability to light, air, and powdery particles.

### EXAMPLE 1

As raw material, a polypropylene produced according to the Ziegler-Natta process was used for the production of the samples, where 0.25% by weight titanium oxide relative to the polymer melt was used.

In so doing, the round or trilobal fibers were produced according to the known spunbond process.

The throughput of the spinning plate was held constant at 162 kg/h, where the spinning plate had in total 5000 holes with a diameter of 0.6 mm. The fibers were easily stretched and had fiber extensions of 279%. This value was determined on a tensile testing machine from the Zwick company with a pretensioning force of 0.1 N, a traction speed of 100 mm/min, and a restraint length of 20 mm.

For the fibers thus obtained and having a round cross section, the fiber diameters were measured in a microscope and relative to the weight of the fiber per unit length, where it was possible to determine a fiber titer of 2.8 dtex. In the case of the trilobal fibers the so-called apparent titer was determined, i.e., the fiber cross section was also measured in a microscope and computed based on the weight per unit length of the round fiber with the same diameter, where for these fibers a titer of 3.7 dtex was determined.

The fibers were preferably laid to form a fleece in the machine direction and transverse to the machine direction. Weights per unit area of 17 g/m², 20 g/m², 34 g/m², 40 g/m², and 51 g/m² were measured according to DIN EN 29073-1 for the laid fleece, both with round and trilobal fiber cross sections, as a function of the fleece density and of the fiber cross section. In this measurement, the fleece densities were between 250 μm and 600 μm. After thermal hardening these fleeces have densities between 0.045 and 0.065 g/cm³ and specific volumes between 15.5 and 20.8 cm³/g.

In these fleeces the air permeability and the screen residue were measured to characterize the physical opacity. According to FIG. 3, for fleeces with a round fiber form, air permeability values which lie between ca. 9000 to 11000 /m² sec were measured. Fleeces with a trilobal cross-sectional form have, due to the higher overlap of the fibers, somewhat lower air permeability values, which are below 8000 /m² sec.

According to FIG. 4, the screen residue for these fleeces was determined, where SAP 35, a superabsorber polymer of the Atofina company, was used as screen feed. Here, the values determined for the screen residue are higher for fleeces with trilobal fibers than the values for fleeces with round fibers with the same weight per unit area. While fleeces with round fibers only have a screen residue>90% at a weight per unit area of 20 g/m², for fleeces with a trilobal cross section these values had already been measured at a weight per unit area of 17 g/m². For fleeces of 15 g/m² and 20 g/m², for the determination of optical opacity, according to FIG. 5 values for reducing the light permeability were measured, which for round fibers lies in the range from ca. 1.5 to 2.5% and for trilobal fibers lies in the range from ca. 6.3 to 8.8%.

Furthermore, for the fleeces according to FIG. 6, the tensile strengths were measured as Fₘₐₓ according to DIN EN 20973-3 in the CD and MD directions, where for fleeces with trilobal fibers and weights per unit area of 17 g/m² to 51 g/m² the tensile strengths lie in the range of 38 N to 85 N in the machine direction and in the range of 25 N and 55 N perpendicular to the machine direction. In a range of weights per unit area of the fleece, specifically the range preferred according to the invention, i.e., from 10 to 20 g/m², fleeces with trilobal fibers have higher strengths than fleeces with round fibers with the same weight per unit area and at the same titer. Thus, for example, for fleeces with trilobal fibers in this range, strengths in the range of 38 N to 50 N in the machine direction and strengths in the range of 25 N and 30 N transverse to the machine direction were measured.

Values for the extension at Fₘₐₓ were determined for these fleeces according to FIG. 7 and according to DIN EN 20973-3. In that determination, in the machine direction the values lie, as a function of the weight per unit area, between 35% and 65% and transverse to the machine direction between 38% and 68%.

### EXAMPLE 2

In all the samples, Ziegler-Natta-catalyzed polypropylene was used as the polymer with the addition of titanium oxide according to example 1, where the spinning process was carried out using the spinning plate according to example 1 with a throughput of 185 kg/h and per meter of spinning plate. Therein round fibers with a fiber titer relative to the weight per unit area of 2.4 dtex and trilobal fibers with a fiber titer of 2.8 dtex were produced, where the determination of the fiber titer was carried out analogously to example 1. In the laid fleeces air permeabilities were measured, which for fleeces with round fibers lie, as a function of the weight per unit area, between 8000 and 10000 /m²sec and for fleeces with trilobal fibers lie between 6500 and 8500 /m²sec. For the determination of the sieve residue the SAP 35 according to example 1 was used. The measured values for fleeces of trilobal fibers are, as a function of the weight per unit area, on the order of magnitude of 88-99% and for fleeces of round fibers between 76 and 95%.

The fleeces according to the invention are suitable for numerous fields of application, in particular in the field of hygiene but also in the field of filter technology or in the field of household cloths.

In the field of hygiene they are used, for example, as a topsheet or backsheet. In this application, the topsheet or backsheet comprise polymer fibers with a non-circular cross section and very low titers and have preferred directions in the spunbond fleece. By using the spunbond fleece hygiene articles made therefrom have a high optical and physical opacity. The high physical opacity has an impact in particular due to the reduced adhesive penetration of the fleece since processing can be done with very small portions of adhesive and low viscosities in the production of the hygiene products.

In the field of filter technology these fleeces of polymer fibers with a non-circular cross section exhibit, due to their fiber geometry, the preferred directions of the fibers in the fleece, and the high packing density associated therewith, a very good retention behavior for dust without in so doing drastically increasing the resistance to air flowing through.

Likewise, the fleeces with a non-circular cross section are suitable in the household field, e.g., as wiping cloths. Since the fiber dimensions correspond to the size of the impurities they are in the position to be able to pick up fine particles and microscopically small dust particles very well.

1. Spunbond fleece of polymer fibers, characterized by the fact that
the polymer fibers have a non-circular cross section,
the polymer fibers have a low fiber titer,
the polymer fibers have preferred directions in the spunbond fleece, and
the spunbond fleece has a high optical and physical opacity with a low weight per unit area.

2. Spunbond fleece according to claim 1, characterized by the fact that the polymer fibers have a flat, trilobal, multi-lobal, or similar structure.

3. Spunbond fleece according to claim 1, characterized by the fact that the polymer fibers have fiber titers in the range of 0.5 dtex to 5 dtex, preferably between 1.4 dtex and 3.5 dtex.

4. Spunbond fleece according to claim 1, characterized by the fact that the polymer fibers are in a preferred direction along and transverse to the machine direction.

5. Spunbond fleece according to claim 1, characterized by the fact that the optical opacity, measured as the reduction of the light permeability, lies in the range of 5 to 20%, preferably 6-9%, relative to the weight per unit area.

6. Spunbond fleece according to claim 1, characterized by the fact that it has weights per unit area between 7 g/m² and 50 g/m², preferably 10 g/m² to 20 g/m².

7. Spunbond fleece according to claim 1, characterized by the fact that the physical opacity relative to the weight per unit area, measured as sieve residue, lies in the range of 75% to 99%, preferably between 90% and 95%.

8. Spunbond fleece according to claim 1, characterized by the fact that the physical opacity relative to the weight per unit area, measured as air permeability, lies in the range of 6·10³ l/m² sec to 9·10³ /m² sec, preferably between 7·10³ l/m² sec and 8·10³/m² sec.

9. Spunbond fleece according to claim 1, characterized by the fact that the polymer fibers consist of polyolefins, PA, or polyester, preferably polypropylene.

10. Spunbond fleece according to claim 1, characterized by the fact that the fleece is coated with an adhesive.

11. Spunbond fleece according to claim 1, characterized by the fact that the fleece has a low penetration of adhesive.

12. Spunbond fleece according to claim 10, characterized by the fact that in the temperature range between 140° C.-160° C. the adhesive has dynamic viscosities in the range of 3000 mPas to 33000 mPas, preferably 4000 mPas to 6000 mpas.

13. Spunbond fleece according to claim 10, characterized by the fact that the portion of adhesive per m² of spunbond fleece lies between 0.5 g and 10 g, preferably between 3 g and 6 g.

14. Spunbond fleece according to claim 1, characterized by the fact that additives, preferably inorganic salts, are used.

15. Spunbond fleece according to claim 13, characterized by the fact that titanium oxides and/or calcium carbonates between 0.1 and 5% by weight, preferably between 0.2 and 0.7% by weight, are used as additives.

16. Use of the spunbond fleece in a hygiene product.

17. Use of the spunbond fleece in a filter material.

18. Use of the spunbond fleece in a household cloth.
